(19) United States
(12) Patent Application Publication
(10) Pub. No.: US 2026/0287237 A1
(43) Pub. Date: Sep. 24, 2026

(54) COLD STORAGE DEVICE

(71) Applicant: B MEDICAL SYSTEMS S.À.R.L., Hosingen (LU)

(72) Inventors: Simone BRUNO, Hosingen (LU); Mario LENTZ, Hosingen (LU)

(73) Assignee: B MEDICAL SYSTEMS S.À.R.L., Hosingen (LU)

(21) Appl. No.: 19/476,686

(22) PCT Filed: Apr. 19, 2024
(86) PCT No.: PCT/EP2024/060666

§ 371 Date: Oct. 18, 2025

(30) Foreign Application Priority Data
Apr. 26, 2023 (GB) 2306157.5

(51) Int. Cl. F25D 3/08; B65D 81/18; F25D 16/00; F25D 23/06; G06K 7/10; H05B 3/03

(52) U.S. Cl. CPC F25D 3/08; B65D 81/18; F25D 16/00; F25D 23/066; G06K 7/10316; H05B 3/03; F25D 2400/02

(57) ABSTRACT

An RFID enabled cold storage device, notably a vaccine storage device, has a cold storage compartment separated from an ice lining by a thermal barrier. The thermal barrier comprises a layer of thermal insulation material and a planar temperature distributing metal sheet, with the planar temperature distributing metal sheet providing an RFID antenna.

This invention relates to a cold storage device, particularly an ice-lined refrigerator and more particularly a solar powered ice-lined refrigerator, notably for vaccines and/or medical products.

To ensure their quality, longevity and effectiveness, vaccines must be stored at an optimum storage temperature, generally ≥+2° C. and ≤+8° C. Exposure to higher or lower temperatures causes deterioration of the vaccines. Specialised vaccine storage refrigerators address these and other practical requirement, for example the avoidance of any significant temperature variation between different positions within a vaccine storage chamber.

One aim of the present invention is to provide an improved ice-lined cold storage device, particularly an improved ice-line vaccine refrigerator.

In accordance with one of its aspects, the present invention provides a cold storage device in accordance with claim 1. Other aspects are defined in other independent claims. The dependent claims define preferred or alternative features.

In one of its aspects, the present invention is based on the realisation that a significant improvement in ice-lined cold storage devices and particularly ice-line vaccine refrigerators can be made by focussing on facilitating stock control for the payload, notably in providing stock control of the payload whilst the payload is being stored within the cold storage device, and particularly in providing synergy between components of an ice-lined cold storage device and a system which can be used for stock control.

An arrangement in which the first and second planar metal sheets:
provide part of their respective thermal barriers between the cold storage compartment and their respective ice-linings; and
together provide part of the RFID antenna;
   allows for arrangement of the RFID detection zone within the cold storage compartment in a way which is compact and which rationalises the required elements of an RFID enabled ice-lined cold storage device.

The arrangement of the RFID antenna may be as disclosed in WO 2016/121130 A1 which is incorporated herein by reference, notably with the two or more electroconductive sheets of the RFID antenna of WO 2016/121130 A1 also providing part of respective thermal barriers between the cold storage compartment and respective ice-linings.

As used herein, the term “ice-lined cold storage device” means a device configured to maintain its cold storage compartment within a controlled temperature range which is below the temperature of its surroundings and to generate an ice lining which acts as a thermal capacitor; in the event of a power interruption the pre-formed ice lining absorbs heat from its surroundings and contributes to maintaining the cold storage compartment within its desired temperature range. For example, where the cold storage device is solar powered, power interruptions will occur when insufficient solar power is available to provide cooling, for example if the solar panels are shaded by clouds or at night.

The ice-lining is preferably water or a water-based ice-lining, for example water comprising one or more additive; the use of water or a water-based ice-lining, notably comprising at least 70 wt %, at least 80 wt % or at least 90 wt % water, allows the use of readily available materials, facilitates maintenance and replacement and allows the ice-lining to be provided by containers which can be filled locally rather than being transported ready-filled. Alternatively, the ice-lining may be a paraffin, a wax, and oil, a fattty acid; or a polyglycol. Preferably, the ice-lining comprises removeable ice-packs; this facilitates construction, transport and maintenance. Notably in this case, each of the ice-linings may be provided by one or more ice-packs. Alternatively, the ice-linings may be provided by one or more ice-reservoirs arranged within the cold storage device, or by a portion of an ice-reservoir arranged within the cold storage device which provides one or more of the ice-linings.

The volume of the cold storage compartment may be ≥15 L and/or ≤260 L; this provides for storage or a suitable quantity of vaccines. It may be ≥40 L, ≥50 L or ≥55 L and/or ≤1500 L, ≤100 L, ≤90 L or ≤85 L.

The hold over time of the cold storage device may be ≥10 hours, ≥12 hours, or ≥14 hours when tested with a surrounding temperature of 32° C.; it may be ≥4 hours, ≥6 hours, or ≥8 hours when tested with a surrounding temperature of 43° C. Particularly for mains powered cold storage devices, the hold over time is preferably ≥20 hours with a surrounding temperature of 27° C. and/or 32° C. and/or 43° C.; particularly for solar powered cold storage devices, the hold over time is preferably ≥72 hours with a surrounding temperature of 27° C. and/or 32° C. and/or 43° C.

The cold storage compartment is preferably entirely filled with air; it may be provided with a means for evacuating any condensation that forms from cooling of the air, for example a drain or water outlet.

The cooling circuit is configured, when in operation, to remove heat from the ice-linings. Preferably, the chilling of the ice-lining serves to simultaneously provide for chilling of the cold storage compartment; this simplifies construction by avoiding the need for a separate chilling arrangement for the cold storage compartment. The cooling circuit is preferably powered by one of more solar panels. The solar panels or other power source may provide a DC voltage, notably a voltage of 12V±2V or 24V±2V and a power which is selected from i) a power which is ≥300 W, or ≥350 W and/or ≤500 W or ≤450 W and ii) a power which is ≥700 W, or ≥750 W and/or ≤900 W or ≤850 W. Alternatively, the cooling circuit may be mains powered, for example from an AC power grid. The cooling circuit may be an AC operated cooling circuit; it may be a DC operated cooling circuit, for example powered from a mains supply by an AC-DC power converter. The electrical heater which is preferably provided is preferably powered by the same power source as the cooling circuit. The electrical heater is preferably configured to operate with a power consumption which is ≥5 W or ≥8 W and/or ≤50 W, ≤30 W or ≤15 W. The ability to provide an effective temperature safeguard with such low levels of power consumption of the electrical heater enables the heater to function even when a small amount of power is available which would not be sufficient to operate the cooling circuit. Thus, for example, when the ice-lined cold storage device is powered by solar panels, as dusk approaches the available solar power will fall to a level insufficient to power the cooling circuit and the ambient temperature will likewise fall. The fall in ambient temperature provides a risk of the temperature of the cold storage compartment falling below its desired minimum temperature but the lower power requirement of the electrical heater can be supplied from the lower level of power still available from the solar panels.

The ice-linings preferably extends around at least 50%, at least 60%, at least 70% or at least 80% of periphery of the cold storage compartment; this helps to ensure consistency of the temperature within the cold storage compartment. The thermal barriers preferable provide an inner lining which circumscribes the cold storage compartment and defines a substantially continuous perimeter of the cold storage compartment; this provides an effective separation between the cold storage compartment and the ice-linings.

Each thermal barrier comprises a respective heat conducting planar metal sheet, having a major surface which faces towards the cold storage compartment and a major surface which faces towards its ice-lining. The heat conducting sheet may have a thermal conductivity measured at 0° C. which is ≥10 W·m⁻¹·K⁻¹ or ≥20 W·m⁻¹·K⁻¹ and preferably which is ≥50 W·m⁻¹·K⁻¹ or ≥100 W·m⁻¹·K⁻¹. An aluminium or aluminium alloy metal sheet provides a useful combination of thermal conduction, physical separation and low weight. The planar metal sheet may have a thickness which is ≥1 mm or ≥2 mm and/or ≤5 mm or ≤4 mm.

It is particularly preferred for each thermal barrier to comprise:
a respective planar metal sheet, notably a planar metal sheet having a major surface which faces towards the cold storage compartment and a major surface which faces towards the ice-lining; and
a respective thermally insulating material, notably a sheet of insulating foam for example expanded polypropylene or expanded polystyrene, which separates the cold storage compartment from the ice-lining and which is arranged between the planar heat conducting sheet and the ice-lining.

The thermally insulating material may have a thermal conductivity measured at 0° C. which is ≤100 mW·m⁻¹·K⁻¹ or ≤80 mW·m⁻¹·K⁻¹ and preferably which is ≤50 mW·m⁻¹·K⁻¹ or ≤40 mW·m⁻¹·K⁻¹.

The planar metal sheets of the thermal barriers preferably form a continuous barrier between the cold storage compartment and the ice-lining so as to provide a continuous metal sheet facing the cold storage compartment and a continuous thermal insulating layer facing the ice lining. The combined effect of the insulating layers and the metal sheets of the thermal barriers provides an advantageous combination of thermal conduction adjacent to the cold storage compartment to mitigate temperature differences within the cold storage compartment, control of heat flow from the cold storage compartment to the ice-lining to avoid over-chilling the cold storage compartment, physical separation and low weight. Arranging an electrical heating element between the heat conducting planar metal sheet and the thermal insulating material further enhances these effects.

Arranging for the heating element to extend around at least 70%, at least 80% or at least 90% of the perimeter of the inner liner and/or the perimeter of the cold storage compartment facilitates heat distribution for the entire cold storage compartment. Arranging the electrical heating element at or near a central plane of the height of the cold storage compartment may be used to simplify the arrangement whilst ensuring that the effect of the electrical heating element extends to the entire cold storage compartment and/or entire inner liner. For example, the electrical heating element may be arranged at a position within the cold storage device which is between i) a horizontal plane which intersects a height corresponding to 25% of the height of the cold storage compartment and/or the inner liner from its base and ii) a horizontal plane which intersects a height corresponding to 75%, 65%, 60% or preferably 55% of the height of the cold storage compartment and or the inner liner from its base.

One advantageous operating mode of a cold storage device, notably a cold storage device described herein, comprises a minimum temperature maintenance procedure. In this procedure, in order to avoid a risk of the temperature of the cold storage compartment falling below its minimum desired temperature, upon detection of the temperature of the cold storage compartment approaching its desired minimum temperature, a control system i) ensures that the cooling circuit is not operated to avoid removing further heat and ii) operates the electrical element to provide heat to the interior of the cold storage device.

Another advantageous operating mode of a cold storage device, notably a cold storage device described herein, comprises an enhanced ice-liner chilling procedure. In this procedure, which may be used for example upon initial start-up of the cold storage device, the electrical element is operated to provide heat during operation of the cooling circuit. This allows a greater amount of heat to be removed from the ice-lining whilst preventing the temperature of the cold storage compartment from reaching a pre-defined minimum temperature. By removing additional heat from the ice-lining in this way the hold-over time of the cold storage device can be increased.

Preferably, the cold storage device comprises a transmitter, notably a wireless transmitter, configured to transmit data derived from detection of RFID tags present at the RFID detection zone to a remote data collection or data monitoring system. Thus, an advantageous method of operating the cold storage device comprises transmitting data derived by the RFID reader from detection of RFID tags present at the RFID detection zone to a remote data collection or data monitoring system.

An embodiment of the invention will now be described, by way of example only, with reference to the accompanying drawings, of which:

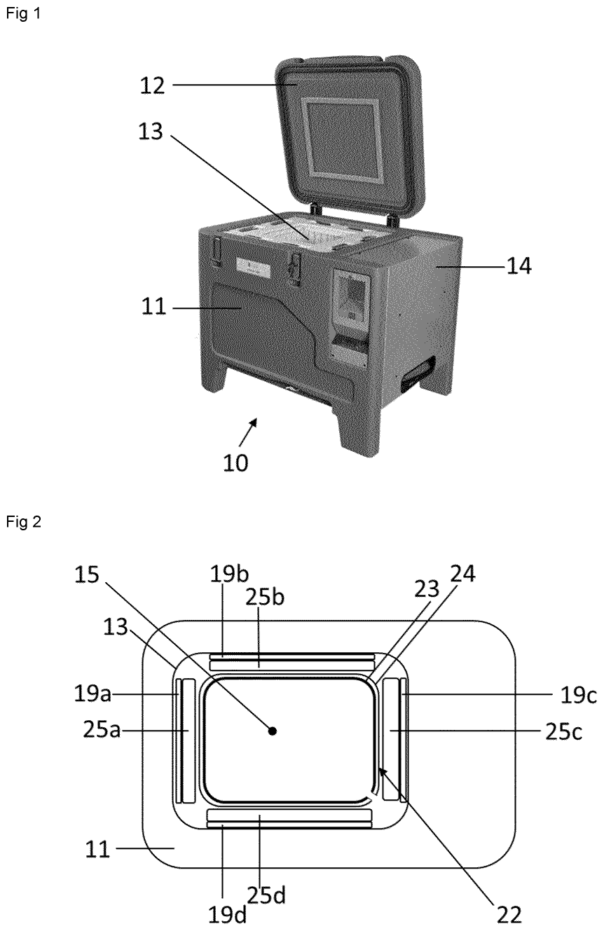

FIG. 1 is a schematic perspective view of an ice-lined cold storage device;

FIG. 2 is a schematic top view (without the lid) of the ice-lined cold storage device;

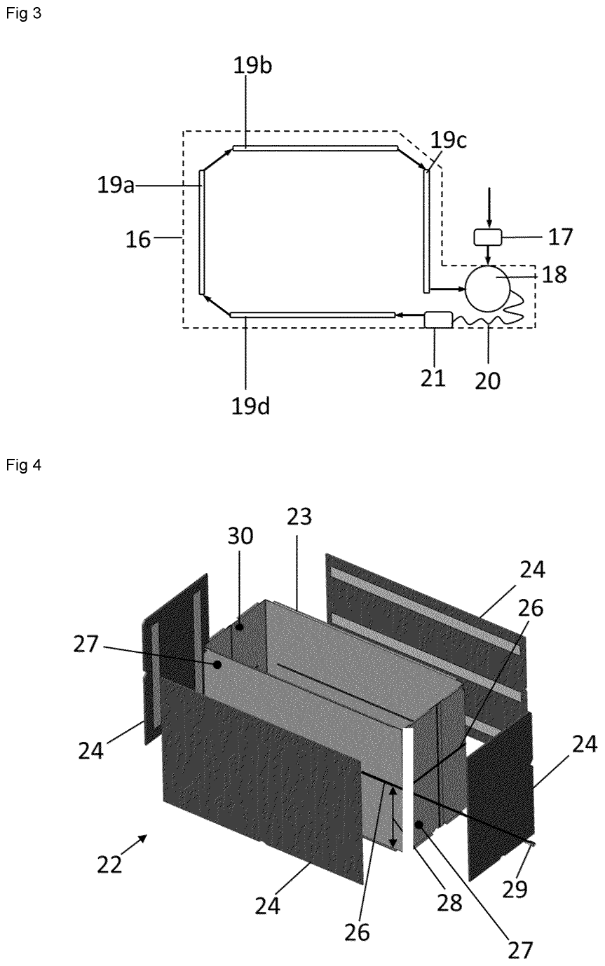

FIG. 3 is a schematic view showing an electrically powered cooling circuit of the ice-lined cold storage device;

FIG. 4 is a schematic exploded perspective view of an inner liner and electrical heater; and

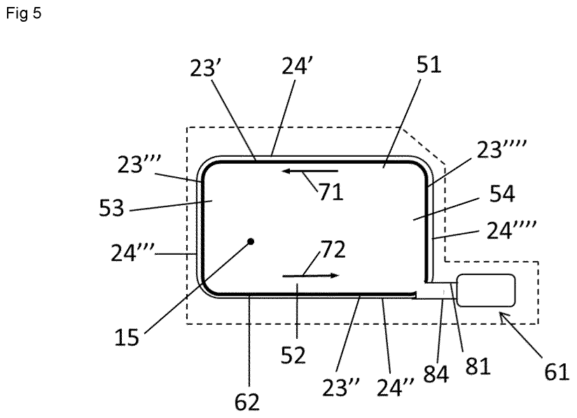

FIG. 5 is a schematic view showing components of an RFID reader.

The ice-lined vaccine refrigerator 10 comprises an insulated, moulded body 11 having an insulated pivoted lid 12. A cooling space 13 within the body 11 is accessible when the lid 12 is open and sealable by closing of the lid 12. Electrical components and control circuitry of the refrigerator 10 are arranged within a component housing 14 which is incorporated into the mounded body 11.

In particular, the ice-lined vaccine refrigerator 10 comprises:
a cold storage compartment 15 within the cooling space 13;
an electrically powered cooling circuit 16,
a power inlet 17 adapted for connection to an external supply of DC power provided from solar panels or from an AC-DC power converter; and
a compressor 18 forming part of the electrically powered cooling circuit 16 of the vaccine refrigerator 10.

The electrically powered cooling circuit 16 comprises: four flat plate evaporators 19a, 19b, 19c, 19d, each arranged at a peripheral side wall of the cooling space 13, the evaporators being fed with refrigerant which is circulated by the compressor 18 through a condenser 20, subsequently through a capillary tube or expansion valve 21 and subsequently through the evaporators before returning to the compressor 18.

An inner liner 22 is arranged within the cooling space 13, the internal periphery of the inner liner 22 defining the peripheral side walls of cold storage compartment 15. The inner liner 22 comprises a substantially continuous metal sheet 23, notably an aluminium sheet, having a thickness of 1-2 mm, and a substantially continuous layer of insulation 24, notably sheets of expanded polypropylene or expanded polystyrene having a thickness of about 8 mm which are adhered to and cover each major surface of the metal sheet which faces an evaporator plate 19a, 19b, 19c, 19d. This is an example of a preferred configuration in which the inner liner provides a substantially continuous sleeve or barrier which separates the cold storage compartment 15 from the ice lining.

A removeable ice pack 25a, 25b, 25c, 25d is arranged in each of the spaces between the evaporator plates 19a, 19b, 19c, 19d and the inner liner 22. The ice packs 25a, 25b, 25c, 25d thus form an ice lining which in this case provides an ice lining at each of four sides of a substantially rectangular vaccine storage compartment 15. In operation, the electrically powered cooling circuit 16 freezes the icepacks 25a, 25b, 25c, 25d which generates an ice lining and cools the vaccine storage compartment 15. As illustrated in FIG. 2, the ice lining does not extent around corner sections of the cold storage compartment 15 but nevertheless extends around the majority and in the illustrated case at least 80% of the periphery of the cold storage compartment 15. Arrangement of the thermally insulated inner liner 22 between the ice packs 25a, 25b, 25c, 25d and the vaccine storage compartment 15 reduces the risk of undesirably cooling the vaccine storage compartment 15 to a temperature of below +2° C.

FIG. 4 illustrates an electrical heating element in the form of a single electrical heating wire 26 which is adhered to a major surface of the inner liner 22, in this case the major surface 27 of the metal sheet 23 which faces the ice lining 25a, 25b, 25c, 25d. The electrical heating wire 26 is thus positioned between the metal sheet 23 and the insulating sheet 24 of the inner liner 22 and passes around the periphery of the inner liner 22 and of the cold storage compartment at a height 28 which corresponds to a horizontal plane which intersects a height corresponding to 50% of the height of the inner liner 22 from its base and which also corresponds in the illustrated example to 50% of the height of the cold storage compartment 15 from its base. The electrical wire heating element 26 comprises a wire loop within an electrically insulated sleeve with each of the two ends of the loop arranged at an electrical heating wire connector 29. A temperature sensor 30 contacts a major surface of metal sheet 23 of the inner liner 22, in the illustrated case the major surface of the inner liner 22 which is in direct contact with the air in the cold storage compartment 15, to provide an indication of the temperature of the cold storage compartment 15. The height position of the temperature sensor is preferably offset from the height position of the electrical heating wire to mitigate against direct heat transfer creating an erroneous temperature reading.

Referring in particular to FIG. 5, the cold storage compartment 15 has a first side portion 51, a second side portion 52, a third side portion 53 and a fourth side portion 54 arranged such that the first side portion 51 and the second side portion 52 are separated by the cold storage compartment 15 and face each other across the cold storage compartment 15, the third side portion 53 and the fourth side portion 54 are separated by the cold storage compartment 15 and face each other across the cold storage compartment 15, with the third side portion 53 being arranged at a portion of a periphery of the cold storage compartment 15 between the first side portion 51 and the second side portion 52 and the fourth side portion being arranged at another portion of the periphery of the cold storage compartment 15 between the first side portion 51 and the second side portion 52.

The moulded body 11 and lid 12 together provide a thermally insulated envelope surrounding the cold storage compartment 15 with the lid 15 providing a cold storage compartment access panel 15 moveable between an open position (illustrated in FIG. 1) in which access is provided to the cold storage compartment 15 and a closed position (not shown) in which the lid 15 blocks access to the cold storage compartment 15 and contributes to maintaining the cold storage compartment 15 at a desired cold storage temperature.

The first ice pack 25b provides a first ice-lining configured to absorb heat from the interior of the cold-storage device, the first ice-lining being arranged between the cold storage compartment 15 and the thermally insulated envelope 11, adjacent to the first side portion 51 of the cold storage compartment 15.

A first portion of the metal sheet of the inner liner 23′ and a first portion of the insulation sheet of the inner liner 24′ provide a first thermal barrier which is arranged between the first ice-lining 25b and the first side portion 51 of the cold storage compartment 15.

The second ice pack 25d provides a second ice-lining configured to absorb heat from the interior of the cold-storage device, the second ice-lining 25d being arranged between the cold storage compartment 15 and the thermally insulated envelope 11, adjacent to the second side portion 52 of the cold storage compartment 15.

A second portion of the metal sheet of the inner liner 23″ and a second portion of the insulation sheet of the inner liner 24″ provides a second thermal barrier which is arranged between the second ice-lining 25d and the second side portion 52 of the cold storage compartment 15.

The first thermal barrier thus comprises i) a first layer of thermal insulation material 24′ which provides a thermal resistance between the cold storage compartment 15 and the first ice-lining 25b and ii) a first, planar, metal sheet 23′ which provides a temperature distribution adjacent to and over an area of the first side portion 51 of the cold storage compartment 15.

Similarly, the second thermal barrier comprises i) a second layer of thermal insulation material 24″ which provides a thermal resistance between the cold storage compartment 15 and the second ice-lining 25d and ii) a second, planar, metal sheet 23″ which provides a temperature distribution adjacent to and over an area of the second side portion 52 of the cold storage compartment 15.

The cold storage device 10 further comprises an RFID reader 61 which comprises an RFID antenna 62, the RFID reader 61 being configured to receive, and preferably transmit, information from RFID tags positioned within a RFID detection zone 15 via the RFID antenna 62. The RFID antenna 61 comprises the first, planar, metal sheet 23′ of the first thermal barrier, the second, planar, metal sheet 23″ of the second thermal barrier and an electrical connector 23″′ which provides an electrical pathway between the first 23′ and second 23″ planar metal sheets such that, in use, the RFID reader 61 controls an electrical flow through the first and second planar metal sheets 23′, 23″ and the electrical connector 23″′ and which generates the RFID detection zone within the cold storage compartment 15 between the first 23′ and second 23″ planar metal sheets.

The first 23′ and second 23″ planar metal sheets are parallel and aligned with respect to each other i.e. at least of portion of the, and preferably the entire, surface areas of the first 23′ and second 23″ planar metal sheets that face the cold storage compartment overlap. Direction of electrical flow through the first planar metal sheet 71 is opposite to direction of electrical flow through the second planar metal sheet 72. The electrical flow may be a direct current or an alternating current.

The cold storage compartment 15 has a third side portion 53 and a fourth side portion 54 with the third side portion 53 and the fourth side portion 54 being separated by the cold storage compartment 15 and facing each other across the cold storage compartment 15. The third side portion 53 is arranged at a portion of a periphery of the cold storage compartment 15 between the first side portion 51 and the second side portion 52 and the fourth side portion 54 is arranged at another portion of the periphery of the cold storage compartment 15 between the first side portion 51 and the second side portion 52.

In the illustrated embodiment, the RFID antenna 62 further comprises a third, planar, metal sheet 23″′ arranged at the third side portion 53 of the cold storage compartment 15, a fourth, planar metal sheet 23″″ arranged at a fourth side portion 54 of the cold storage compartment 15 and an electrical connector 23′ which provides an electrical pathway between the third 23″′ and fourth 24″″ planar metal sheets such that, in use, the RFID reader 61 controls an electrical flow through the third 23″′ and fourth 23″″ planar metal sheets and the electrical connector 23′ and which generates a RFID detection zone within the cold storage compartment 15 between the third 23″′ and fourth 23″″ planar metal sheets. The third 23″′ and fourth 23″″ planar metal sheets are parallel and aligned with respect to each other, and direction of electrical flow through the third planar metal sheet is opposite to direction of electrical flow through the fourth planar metal sheet.

The third ice pack 25a provides a third ice-lining configured to absorb heat from the interior of the cold-storage device 13, the third ice-lining 25a being arranged between the cold storage compartment 15 and the thermally insulated envelope 11, adjacent to the third side portion 53 of the cold storage compartment. A third thermal barrier provided by i) a third layer of thermal insulation material 24″′ which provides a thermal resistance between the cold storage compartment 15 and the third ice-lining 25a and ii) a third planar, metal sheet 24″′ which provides a temperature distribution adjacent to and over an area of the third side portion 53 of the cold storage compartment is arranged between the third ice-lining 25a and the third side portion of the cold storage compartment 53. The fourth ice-pack 25c provides a fourth ice-lining configured to absorb heat from the interior of the cold-storage device 13, the fourth ice-lining 25c being arranged between the cold storage compartment 15 and the thermally insulated envelope 11, adjacent to the fourth side portion of the cold storage compartment 54. A fourth thermal barrier provided by i) a fourth layer of thermal insulation material 24″″ which provides a thermal resistance between the cold storage compartment 15 and the fourth ice-lining 25c and ii) a fourth planar, metal sheet 23″″ which provides a temperature distribution adjacent to and over an area of the fourth side portion of the cold storage compartment 54, is arranged between the fourth ice-lining 25c and the fourth side portion of the cold storage compartment 54.

The electrically powered cooling circuit is configured, when in operation, to remove heat from the first 25b, second, 25d, third 25a and fourth 25c ice-linings via their respective adjacent evaporators 19b, 19d, 19a, 19c.

The first, second, third and fourth planar metal sheets 23′, 23″, 23″′, 23″″ are provided by a continuous length of electroconductive 1 mm thick aluminium sheet material, the continuous length of aluminium sheet material be formed by bending, to provide the first, second, third and fourth planar, metal sheets 23′, 23″, 23″′, 23″″ at respective portions of its continuous length. An electrical separation is provided between the first 23′ and fourth 23″′ planar metal sheets so that the continuous length of aluminium sheet material provides a non-continuous tube around the cold storage compartment 15. In the illustrated embodiment, the first, second, third and fourth planar metal sheets together circumscribes the cold storage compartment.

Thus, in the illustrated embodiment, the RFID antenna 62 comprises:
the first, planar, metal sheet 23′ of the first thermal barrier and the second, planar, metal sheet 23″ of the second thermal barrier with the electrical connector which provides an electrical pathway between the first and second planar metal sheets being provided by the third planar metal sheet 23″′ of the third thermal barrier; and
the third, planar, metal sheet 23″′ of the third thermal barrier and the fourth, planar, metal sheet 23″″ of the fourth thermal barrier with the electrical connector which provides an electrical pathway between the third and fourth planar metal sheets being provided by the first planar metal sheet 23′ of the first thermal barrier
   In this arrangement, an electrical connection 81 is provided between the RFID reader 61 and an edge of the first, planar, metal sheet 23′ and a further electrical connection 84 is provided between the RFID reader 61 and an edge of the fourth, planar, metal sheet 23″′.

Electrical connection:
between an edge of the first planar metal sheet 23′ and an edge of the third planar metal sheet 23″′;
between an edge of the first planar metal sheet 23′ and an edge of the fourth planar metal sheet 23″″; and
between an edge of the third planar metal sheet 23″″ and an edge of the second planar metal sheet 23″;
   is arranged by the respective edges being connected along their entire lengths. This is particularly advantageous for facilitating homogeneous electrical flow between the planar metal sheets. In the illustrated embodiment, this is achieved by forming each of the planar metal sheets by bending a continuous metal sheet.

### LIST OF REFERENCE NUMBERS

10 ice-lined vaccine refrigerator
11 moulded body
12 lid
13 cooling space
14 component housing
15 vaccine storage compartment (cold storage compartment)
16 electrically powered cooling circuit
17 power inlet
18 compressor
19a evaporator
19b evaporator
19c evaporator
19d evaporator
20 condenser
21 expansion valve
22 inner liner
23 metal sheet of inner liner
23′ first, planar, metal sheet
23″ second, planar, metal sheet
23″′ third, planar, metal sheet
23″″ fourth, planar, metal sheet
24 insulation sheet of inner liner
24′ first layer of thermal insulation material
24″ second layer of thermal insulation material
24″′ third layer of thermal insulation material
24″″ fourth layer of thermal insulation material
25a third ice pack
25b first ice pack
25c fourth ice pack
25d second ice pack
26 electrical heating wire
27 major surface of metal sheet of inner liner
28 height of electrical heating wire
29 electrical heating wire connector
30 temperature sensor
51 first side portion
52 second side portion
53 third side portion
54 fourth side portion
61 RFID reader
62 RFID antenna
71 direction of electrical flow
72 direction of electrical flow
81 electrical connection
84 electrical connection

1-20. (canceled)

21. An ice-lined vaccine cold storage device, comprising:
a cold storage compartment arranged at an interior of the ice-lined cold storage device, the cold storage compartment having a first side portion and a second side portion with the first side portion and the second side portion being separated by the cold storage compartment and facing each other across the cold storage compartment;
a thermally insulated envelope surrounding the cold storage compartment, the thermally insulated envelope having a cold storage compartment access panel moveable between an open position in which access is provided to the cold storage compartment and a closed position in which the access panel blocks access to the cold storage compartment and contributes to maintaining the cold storage compartment at a desired cold storage temperature;
a first ice-lining configured to absorb heat from the interior of the cold-storage device, the first ice-lining being arranged between the cold storage compartment and the thermally insulated envelope, adjacent to the first side portion of the cold storage compartment;
a first thermal barrier which is arranged between the first ice-lining and the first side portion of the cold storage compartment;
a second ice-lining configured to absorb heat from the interior of the cold-storage device, the second ice-lining being arranged between the cold storage compartment and the thermally insulated envelope, adjacent to the second side portion of the cold storage compartment;
a second thermal barrier which is arranged between the second ice-lining and the second side portion of the cold storage compartment; and
an electrically powered cooling circuit comprising one or more evaporators, a condenser and a compressor, the compressor being configured, when in operation, to circulate a refrigerant through the cooling circuit so as to remove heat from the first and second ice-linings;
wherein the first thermal barrier comprises i) a first layer of thermal insulation material which provides a thermal resistance between the cold storage compartment and the first ice-lining and ii) a first, planar, metal sheet which provides a temperature distribution adjacent to and over an area of the first side portion of the cold storage compartment;
wherein the second thermal barrier comprises i) a second layer of thermal insulation material which provides a thermal resistance between the cold storage compartment and the second ice-lining and ii) a second, planar, metal sheet which provides a temperature distribution adjacent to and over an area of the second side portion of the cold storage compartment;
and wherein the cold storage device further comprises an RFID reader which comprises an RFID antenna, the RFID reader being configured to receive information from RFID tags positioned within a RFID detection zone via the RFID antenna;
wherein the RFID antenna comprises the first, planar, metal sheet of the first thermal barrier, the second, planar, metal sheet of the second thermal barrier and an electrical connector which provides an electrical pathway between the first and second planar metal sheets such that, in use, the RFID reader controls an electrical flow through the first and second planar metal sheets and the electrical connector which generates the RFID detection zone within the cold storage compartment between the first and second planar metal sheets.

22. The ice-lined cold storage device in accordance with claim 21,
in which the first and second planar metal sheets are parallel and aligned with respect to each other, and in which direction of electrical flow through the first planar metal sheet is opposite to direction of electrical flow through the second planar metal sheet.

23. The ice-lined cold storage device in accordance with claim 21,
in which the cold storage compartment has a third side portion and a fourth side portion with the third side portion and the fourth side portion being separated by the cold storage compartment and facing each other across the cold storage compartment, with the third side portion being arranged at a portion of a periphery of the cold storage compartment between the first side portion and the second side portion and the fourth side portion being arranged at another portion of the periphery of the cold storage compartment between the first side portion and the second side portion;
and in which the RFID antenna further comprises
a third, planar, metal sheet arranged at the third side portion of the cold storage compartment;
a fourth, planar metal sheet arranged at a fourth side portion of the cold storage compartment; and
an electrical connector which provides an electrical pathway between the third and fourth planar metal sheets such that, in use, the RFID reader controls an electrical flow through the third and fourth planar metal sheets and the electrical connector which generates the RFID detection zone within the cold storage compartment between the third and fourth planar metal sheets.

24. The ice-lined cold storage device in accordance with claim 23,
in which the third and fourth planar metal sheets are parallel and aligned with respect to each other, and in which direction of electrical flow through the third planar metal sheet is opposite to direction of electrical flow through the fourth planar metal sheet.

25. The ice-lined cold storage device in accordance with claim 23,
in which the cold storage device further comprises
a third ice-lining configured to absorb heat from the interior of the cold-storage device, the third ice-lining being arranged between the cold storage compartment and the thermally insulated envelope, adjacent to the third side portion of the cold storage compartment;
a third thermal barrier which is arranged between the third ice-lining and the third side portion of the cold storage compartment;
a fourth ice-lining configured to absorb heat from the interior of the cold-storage device, the fourth ice-lining being arranged between the cold storage compartment and the thermally insulated envelope, adjacent to the fourth side portion of the cold storage compartment;
a fourth thermal barrier which is arranged between the fourth ice-lining and the fourth side portion of the cold storage compartment;
in which the electrically powered cooling circuit is configured, when in operation, to remove heat from the third and fourth ice-linings;
wherein the third thermal barrier comprises i) a third layer of thermal insulation material which provides a thermal resistance between the cold storage compartment and the third ice-lining and ii) the third planar, metal sheet which provides a temperature distribution adjacent to and over an area of the third side portion of the cold storage compartment;
wherein the fourth thermal barrier comprises i) a fourth layer of thermal insulation material which provides a thermal resistance between the cold storage compartment and the fourth ice-lining and ii) the fourth planar, metal sheet which provides a temperature distribution adjacent to and over an area of the fourth side portion of the cold storage compartment.

26. The ice-lined cold storage device in accordance with claim 23,
wherein the first, second, third and fourth planar metal sheets are provided by a continuous length of electroconductive metal sheet material, the continuous length of electroconductive metal sheet material being formed to provide the first, second, third and fourth planar, metal sheets at respective portions of the continuous length of the electroconductive metal sheet material with an electrical separation being provided at at least one portion of the continuous length of electroconductive metal sheet material so that the continuous length of electroconductive metal sheet material provides a non-continuous tube around the cold storage compartment, and wherein the first, second, third and fourth planar metal sheets together circumscribes the cold storage compartment.

27. The ice-lined cold storage device in accordance with claim 21 further comprising at least one of the following features:
in which each of the planar metal sheets is provided by sheet aluminium,
in which each of the planar metal sheets is provided by sheet aluminium having a thickness in the range 0.5 mm to 4 mm,
in which each of the planar metal sheets is provided by sheet aluminium having a thickness in the range 1 to 2 mm.

28. The ice-lined cold storage device in accordance with claim 21 further comprising at least one of the following features:
in which each sheet of thermal insulation is arranged between its respective, planar metal sheet and its respective ice-lining,
in which each sheet of thermal insulation is arranged between its respective, planar metal sheet and its respective ice-lining, and in which each sheet of thermal insulation is secured to its respective planar metal sheet,
in which each sheet of thermal insulation is arranged between its respective, planar metal sheet and its respective ice-lining, and in which each sheet of thermal insulation is bonded to its respective planar metal sheet,
in which each sheet of thermal insulation is provided by a sheet of foam insulation material,
in which each sheet of thermal insulation is provided by a sheet of foam insulation material having a thickness in the range 2 mm to 20 mm,
in which each sheet of thermal insulation is provided by a sheet of foam insulation material selected from polypropylene foam, expanded polypropylene; expanded polystyrene and extruded polystyrene,
in which each sheet of thermal insulation is provided by a sheet of foam insulation material having a thickness in the range 2 mm to 20 mm and selected from polypropylene foam, expanded polypropylene; expanded polystyrene and extruded polystyrene.

29. The ice-lined cold storage device in accordance with claim 21 and further comprising at least one of the following features:
in which the cold storage device further comprises an electrical heater arranged within the cold storage device and configured, when in use, to provide heat to the cold storage compartment,
in which the cold storage device further comprises an electrical heater arranged within the cold storage device and configured, when in use, to provide heat to the cold storage compartment, and in which the electrical heater is controlled on the basis of a temperature sensor arranged in contact with a major surface of one of the planar metal sheets which is in direct contact with the cold storage compartment and which provides an indication of a temperature of the cold storage compartment,
in which the cold storage device further comprises an electrical heater arranged within the cold storage device and configured, when in use, to provide heat to the cold storage compartment, and in which the electrical heater is provided by an electrical heating wire arranged at a major surface of one or more of the planar metal sheets which faces away from the cold storage compartment,
in which the cold storage device further comprises an electrical heater arranged within the cold storage device and configured, when in use, to provide heat to the cold storage compartment, and in which the electrical heater is provided by an electrical heater arranged at a base of the cold storage compartment,
in which the electrically powered cooling circuit is controlled on the basis of a temperature sensor which provides an indication of a temperature of the cold storage compartment, a temperature sensor being arranged in contact with a major surface of one of the planar metal sheets which is in direct contact with the cold storage compartment.

30. The ice-lined cold storage device in accordance with claim 1, in which the ice-lined storage device is configured to operate with its cold storage compartment having a temperature which is maintained between +2° C. and +8° C.

31. The ice-lined cold storage device in accordance with claim 21, in which the electrically powered cooling circuit and the RFID reader are solar powered.

32. The ice-lined cold storage device in accordance with claim 21, in which the thermally insulated envelope surrounding the cold storage compartment consists essentially of a thermally insulated non-metallic plastics envelope.

33. The ice-lined cold storage device in accordance with claim 21, in which the ice-lined cold storage device further comprises a non-metallic product holder arranged within the cold storage compartment.

34. The ice-lined cold storage device in accordance with claim 21 and further comprising at least one of the following features:
in which the cold storage compartment comprises a plurality of vaccine boxes,
in which the cold storage compartment comprises a plurality of vaccine boxes, and in which the ice-lined cold storage device comprises a non-metallic product holder arranged within the cold storage compartment and in which the plurality of vaccine boxes are retained within the non-metallic product holder, each vaccine box comprising a plurality of vaccine vials, each of the plurality of vaccine boxes having an RFID tag, and in which each of the RFID tags is readable by the RFID reader,
in which the cold storage compartment comprises a plurality of vaccine boxes, and in which the ice-lined cold storage device comprises a non-metallic product holder arranged within the cold storage compartment and in which the plurality of vaccine boxes are retained within the non-metallic product holder, each vaccine box comprising a plurality of vaccine vials, each of the plurality of vaccine boxes having an RFID tag secured to an outer surface of the vaccine box, and in which each of the RFID tags is readable by the RFID reader.

35. An ice-lined vaccine cold storage device,
in which the ice-lined vaccine cold storage device is configured to operate with its cold storage compartment having a temperature which is maintained between +2° C. and +8° C., the ice-lined vaccine cold storage device comprising:
a cold storage compartment arranged at an interior of the ice-lined cold storage device, the cold storage compartment having a first side portion, a second side portion, a third side portion and a fourth side portion, with the first side portion and the second side portion being separated by the cold storage compartment and facing each other across the cold storage compartment, with the third side portion and the fourth side portion being separated by the cold storage compartment and facing each other across the cold storage compartment, with the third side portion being arranged at a portion of a periphery of the cold storage compartment between the first side portion and the second side portion and the fourth side portion being arranged at another portion of the periphery of the cold storage compartment between the first side portion and the second side portion;
a thermally insulated envelope surrounding the cold storage compartment, the thermally insulated envelope having a cold storage compartment access panel moveable between an open position in which access is provided to the cold storage compartment and a closed position in which the access panel blocks access to the cold storage compartment and contributes to maintaining the cold storage compartment at a desired cold storage temperature;
a first ice-lining configured to absorb heat from the interior of the cold-storage device, the first ice-lining being arranged between the cold storage compartment and the thermally insulated envelope, adjacent to the first side portion of the cold storage compartment;
a first thermal barrier which is arranged between the first ice-lining and the first side portion of the cold storage compartment;
a second ice-lining configured to absorb heat from the interior of the cold-storage device, the second ice-lining being arranged between the cold storage compartment and the thermally insulated envelope, adjacent to the second side portion of the cold storage compartment;
a second thermal barrier which is arranged between the second ice-lining and the second side portion of the cold storage compartment; and
an electrically powered cooling circuit comprising one or more evaporators, a condenser and a compressor, the compressor being configured, when in operation, to circulate a refrigerant through the cooling circuit so as to remove heat from the first and second ice-linings;
wherein the first thermal barrier comprises i) a first layer of thermal insulation material which provides a thermal resistance between the cold storage compartment and the first ice-lining and ii) a first, planar, metal sheet which provides a temperature distribution adjacent to and over an area of the first side portion of the cold storage compartment;
wherein the second thermal barrier comprises i) a second layer of thermal insulation material which provides a thermal resistance between the cold storage compartment and the second ice-lining and ii) a second, planar, metal sheet which provides a temperature distribution adjacent to and over an area of the second side portion of the cold storage compartment;
and wherein the cold storage device further comprises an RFID reader which comprises an RFID antenna, the RFID reader being configured to receive information from RFID tags positioned within a RFID detection zone via the RFID antenna;
wherein the RFID antenna comprises
the first, planar, metal sheet of the first thermal barrier,
the second, planar, metal sheet of the second thermal barrier,
a third, planar, metal sheet arranged at the third side portion of the cold storage compartment; and
a fourth, planar metal sheet arranged at a fourth side portion of the cold storage compartment;
such that, in use, the RFID reader controls an electrical flow through the first, second, third and fourth planar metal sheets and generates the RFID detection zone within the cold storage compartment between the first and second planar metal sheets and between the third and fourth planar metal sheets.

36. The ice-lined cold storage device in accordance with claim 35,
in which the first and second planar metal sheets are parallel and aligned with respect to each other, and in which direction of electrical flow through the first planar metal and in which the third and fourth planar metal sheets are parallel and aligned with respect to each other, and in which direction of electrical flow through the third planar metal sheet is opposite to direction of electrical flow through the fourth planar metal sheet.

37. The ice-lined cold storage device in accordance with claim 35,
wherein the first, second, third and fourth planar metal sheets are provided by a continuous length of electroconductive metal sheet material, the continuous length of electroconductive metal sheet material being formed to provide the first, second, third and fourth planar, metal sheets at respective portions of the continuous length of the electroconductive metal sheet material with an electrical separation being provided at at least one portion of the continuous length of electroconductive metal sheet material so that the continuous length of electroconductive metal sheet material provides a non-continuous tube around the cold storage compartment, and wherein the first, second, third and fourth planar metal sheets together circumscribes the cold storage compartment.

38. The ice-lined cold storage device in accordance with claim 35,
in which the electrically powered cooling circuit and the RFID reader are solar powered.

39. A method of operating an ice-lined cold storage device in accordance with claim 21 comprising periodically running an RFID detection cycle, in which the RFID detection cycle comprises i) switching the RFID reader into an activated, powered state and using the RFID reader in its activated powered state to receive information from RFID tags positioned within the RFID detection zone via the RFID antenna and ii) subsequently switching the RFID reader into a low-power, or no power deactivated state.

40. The method of operating an ice-lined cold storage device in accordance with claim 39, comprising detecting movement of the cold storage compartment access panel between the open position and the closed position and running the RFID detection cycle upon detecting that the cold storage compartment access panel has been moved from the open position to the closed position.
